(19) United States
(12) Patent Application Publication
(10) Pub. No.: US 2003/0188465 A1
(43) Pub. Date: Oct. 9, 2003

(54) Creative business cards

(76) Inventor: Diogenes A. Ruiz, Raleigh, NC (US)

Correspondence Address: COATS & BENNETT, PLLC, P O BOX 5, RALEIGH, NC, 27602, US

(21) Appl. No.: 10/412,140

(22) Filed: Apr. 11, 2003

Related U.S. Application Data
(62) Division of application No. 09/870,570, filed on May 31, 2001.

(51) Int. Cl. G09F 1/00

(52) U.S. Cl. 40/124.01; 40/360

(57) ABSTRACT

A business card comprises a super hero template with a facial caricature of the entity whose business card it is on one side of the card. The opposite side comprises information about the entity as well as game information and the like. The card may be used as a collectable card, a business card, or part of a game.

### BACKGROUND OF THE INVENTION

1. Field of the Invention

The present invention relates to business cards that may be used in a game and add an element of novelty to the presentation of the business card.

2. Description of the Related Art

Business cards have been around for many years and provide individuals with a way to provide information about themselves or about their company in a convenient manner. Business cards are typically two inches by three and one half inches (5.08 cm×8.89 cm) which means that they fit easily within a wallet. Generally a business card contains the name and contact information about an individual. This contact information may include a company or business name for which the individual is employed.

Over the past few years, business cards have evolved to some extent. It is now not uncommon for a photograph to be placed on a business card. For example, real estate agents in particular seem to have photographs on their business card.

Likewise, www.egocards.com offers business cards that have cartoon like images on the front surface of the card and a miscellany of information on the back surface.

In an unrelated field of endeavor, collectable card games have seen a flurry of activity. Related in some ways to baseball cards and the like, this industry is led by Wizards of the Coast and their game MAGIC: THE GATHERING, which spawned U.S. Pat. No. 5,662,332. Others followed suit with competing games such as ILLUMINATI, SPELLFIRE, and the like. Some companies used lucrative licenses such as STAR TREK, STAR WARS, POKEMON, HIGHLANDER, or the like to promote their games, with varying degrees of success. While forming a booming retail opportunity, such collectable card games are not used in a business context.

A market exists for business cards that may be used both as business cards and as the basis for a collectable card set.

### SUMMARY OF THE INVENTION

The present invention comprises a business card that has a super hero body template displayed on one face of the business card along with a caricature of the face of the person whose business card it is. On the other side, the business card may comprise the following sorts of information: name, company name, company address, phone number, email address, company web address, favorite food, favorite color, animal guide, and the like as well as a photograph of the person whose business card it is.

In another embodiment, the business card is in fact a larger card, folded down a longitudinal axis such that the resulting folded card is the size of a normal business card. The information may be rearranged as needed or desired. Likewise, the addition of the extra space allows additional information to be positioned on the card.

### BRIEF DESCRIPTION OF THE DRAWINGS

FIG. 1 illustrates a side of a first embodiment of the card of the present invention;

FIG. 2 illustrates an opposite side of the card of FIG. 1;

FIG. 3 illustrates a perspective view of a second embodiment of the card of the present invention in a folded posture;

FIG. 4 illustrates a first side of the card of FIG. 3; and

FIG. 5 illustrates a second side of the card of FIG. 3.

### DETAILED DESCRIPTION OF THE DRAWINGS

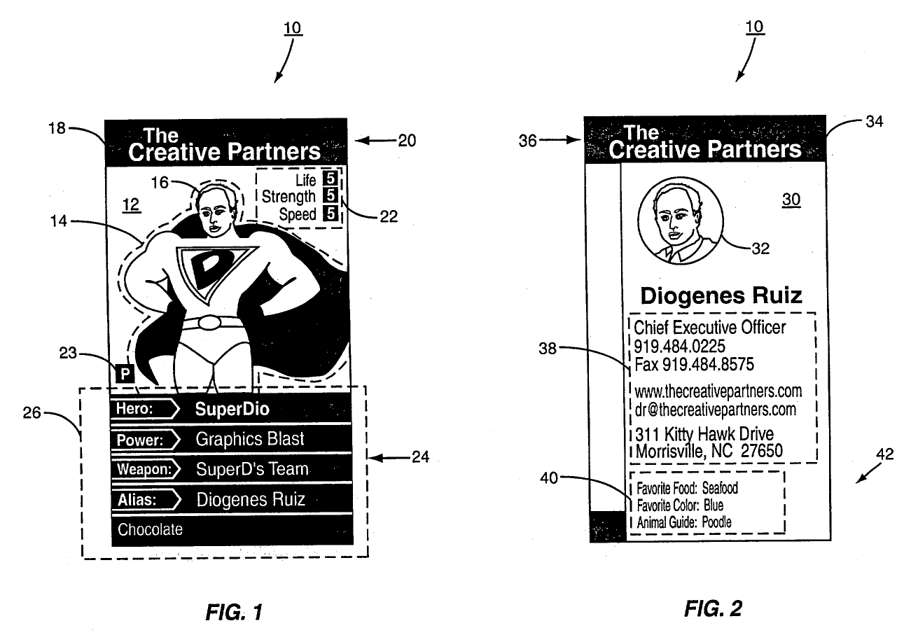

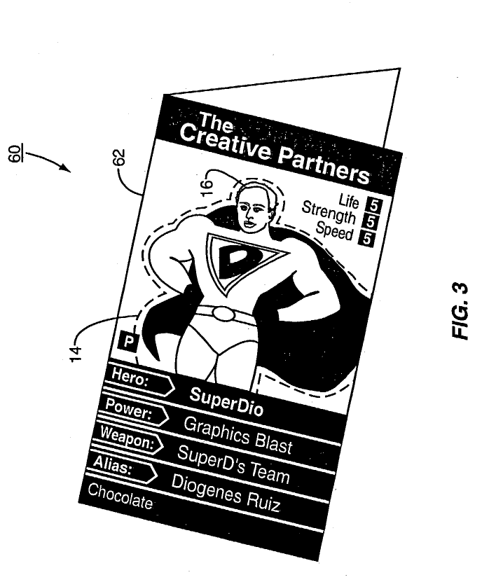

The present invention comprises a business card that is easily adaptable for a collectible card set and for use in a card game. A first embodiment of a card 10 is illustrated in FIGS. 1 and 2. FIG. 1 illustrates a first side 12 of card 10. Card 10 is a standard business card size and may be made out of appropriately stiff card stock material or other semi-rigid paper material. First side 12 comprises a super hero body template 14 with a head caricature 16 imposed thereon. Note that other body shapes, sizes, and such may comprise the super hero body template 14. Likewise, while a male template is shown, a female template is certainly contemplated by the present invention. A business entity title line 18 may be positioned at the top 20 of the first side 12. Game statistics 22 may be positioned approximate to the super hero body template 14. Further, business type information 23 may be positioned on first side 12. Business type information 23 may comprise, in one embodiment, a P, S, NP, or PS, standing for Product, Service, Non Profit, or Product and Service respectively. Business type information 23 may be used as part of a set designation, for a game purpose, or other purpose as needed or desired. Other codes are also contemplated to classify other possible business and non-business types. Approximate bottom 24 of first side 12 additional indicia 26 may be disposed. In an exemplary embodiment, such fictional indicia may comprise a hero name, a power, a weapon, a weakness, and an alias. Note that the weakness may not be labeled as such, but rather may merely be a listing with people familiar with the card 10 aware that the line in question refers to a weakness. The power and weakness may be used in a game as described elsewhere.

FIG. 2 illustrates a second side 30 of card 10. Second side 30 is positioned on the side of the card 10 opposite that of first side 12, as is well understood. Second side 30 may comprise a photograph 32 of the individual for whom business card 10 was created. Additionally, a business entity title line 34 may be positioned near top 36 of second side 30. Business information 38 may be positioned, in one embodiment, inferiorly of the photograph 32. Other positions are possible if desired. Personal information 40 may be positioned near bottom 42 of second side 30. Exemplary personal information 40 comprises a favorite food, a favorite color, and an animal guide.

Additional information may be disposed on card 10 as needed or desired. This additional information may comprise information relating to which set of cards this particular card 10 belongs and/or game-related information relating to a game in which this card 10 may be used. These concepts are explored in greater detail below.

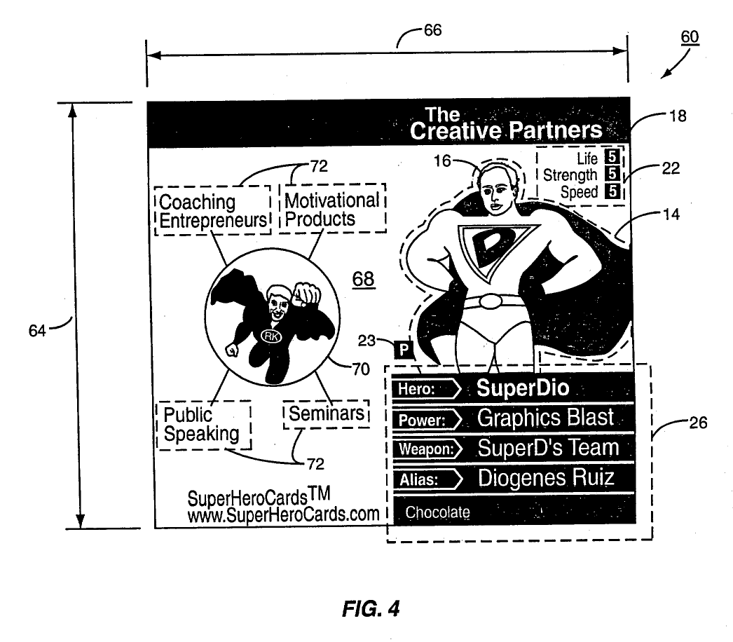

FIG. 3 illustrates a second embodiment of the present invention, namely card 60. Card 60 is similar in many ways to card 10 but, as illustrated in FIG. 3, is a bi-fold card that folds along fold line 62 into a size equivalent to a standard business card. Fold line 62 extends along a longitudinal axis 64 (FIG. 4) of the card 60 and may in a first embodiment be in the center of the lateral axis 66 (FIG. 4) of the card 60. In alternate embodiments, the fold line 62 may be located at other positions on the lateral axis 66 of the card 60. An advantage of the second embodiment over the first embodiment is that the second embodiment is larger than the first. This allows more information to be presented thereon and/or presented in a larger typeface for easier reading.

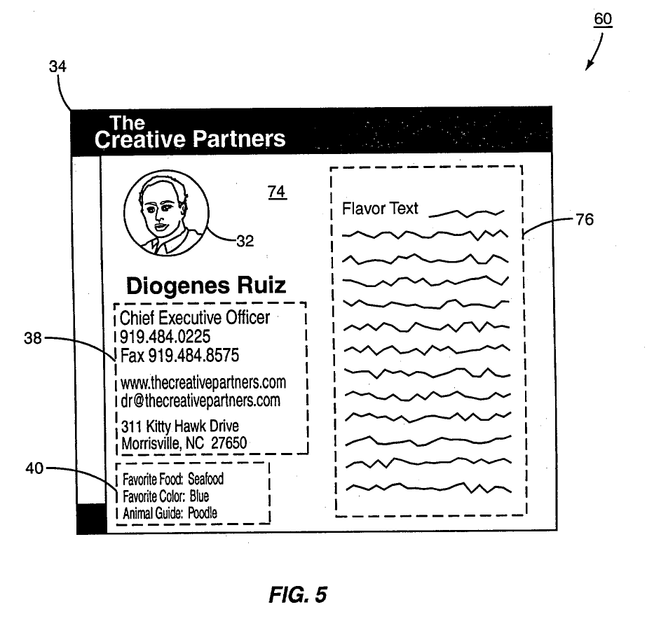

FIGS. 4 and 5 illustrate card 60 in an unfolded state. Card 60 may comprise a first side 68 that forms the exterior of the card 60 when folded. First side 68 may comprise comprises a super hero body template 14 with a head caricature 16 imposed thereon. Note that other body shapes, sizes, and such may comprise the super hero body template 14. Likewise, while a male template is shown, a female template is certainly contemplated by the present invention. A business entity title line 18 may also be displayed. Game statistics 22 may be positioned proximate to the super hero body template 14. Likewise, business type information 23 may likewise be positioned on first side 68. Additional fictional indicia 26 may be disposed on first side 68. In an exemplary embodiment, such fictional indicia may comprise a hero name, a power, a weapon, weakness, and an alias. Additionally, because card 60 comprises more surface area on first side 68, more information may be displayed. In the exemplary embodiment, a miniature image 70 of the super hero body template 14 and head caricature 16 are used along with business related indicia 72. Business related indicia 72 may comprise slogans, blips about goods or services sold or the like as needed or desired.

Second side 74 of card 60 is illustrated in FIG. 5. Second side 74 may comprise a photograph 32 of the individual for whom business card 10 was created. Additionally, a business entity title line 34 may be present. Business information 38 may be positioned inferiorly of the photograph 32. Personal information 40 may also be present. Exemplary personal information 40 comprises a favorite food, a favorite color, and an animal guide. Again, card 60 is larger than card 30 so second side 74 may further comprise flavor text 76. Flavor text 76 may be related to the business for which the business card is intended, more personal information or the like as needed or desired.

Cards 10 and 60 may be part of a larger set. The cards within a particular set may be related one to another by the fact that they are common employees of a single employer. Alternatively, sets may be arranged for particular industries or the like as needed or desired. Still further, there may be opportunities to collect the cards 10, 60 through an online interface, networking meetings, and the like.

With or without the sets, the cards 10 and 60 maybe used not only for business promotion purposes, such as acquiring the cards 10, 60 and passing them out in business environments, but also available for game use such as in a collectable card game or the like.

While not preferred, it is possible to create fictional business cards to round out sets or complete decks for a game. This is not preferred because it may create confusion amongst individuals who have received “real” business cards from the set as well as the fictional business cards and try to contact a fictional individual from a fictional business card. However, explanatory indicia may be used to reduce this likelihood if needed or desired.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A business card comprising:
a first face and a second face, said faces oppositely positioned one from the other;
a super hero body template disposed on said first face;
a caricature of a head contiguous said super hero body template; and
business related information disposed on said second face.

2. The business card of claim 1 further comprising game information disposed one of said first and second faces.

3. The business card of claim 1 further comprising a photograph of an individual from which said caricature is derived, said photograph disposed on said second face.

4. The business card of claim 1 further comprising personal information, said personal information disposed on said second face.

5. The business card of claim 1 further comprising a business entity title line positioned on one of said faces.

6. The business card of claim 1 further comprising a business entity title line positioned on both of said faces.

7. A business card comprising:
a first and a second face, said faces oppositely positioned one from the other;
a fold running along a longitudinal axis of said card, thereby forming a folded business card;
a super hero body template disposed on said first face;
a caricature of a head contiguous said super hero body template; and
business related information disposed on said second face

8. The business card of claim 7 further comprising a lateral axis comprising a middle, said fold intersecting the middle of said lateral axis.

9. The business card of claim 7 further comprising game information disposed one of said first and second faces.

10. The business card of claim 7 further comprising a photograph of an individual from which said caricature is derived, said photograph disposed on said second face.

11. The business card of claim 7 further comprising personal information, said personal information disposed on said second face.

12. The business card of claim 7 further comprising a business entity title line positioned on one of said faces.

13. The business card of claim 7 further comprising a business entity title line positioned on both of said faces.

14. A method of promoting a business comprising:
creating a business card comprising:
a first face and a second face, said faces oppositely positioned one from the other;
a super hero body template disposed on said first face;
a caricature of a head contiguous said super hero body template; and
business related information disposed on said second face; and passing out said business card.

15. The method of claim 14 further comprising creating a set of related business cards.

16. The method of claim 15 where in creating a set of related business cards comprises creating a set of business cards amongst different people from a single company.

17. The method of claim 15 wherein creating a set of related business cards comprises creating a set of business cards amongst different people from a single industry.
